(19) United States
(12) Patent Application Publication
(10) Pub. No.: US 2024/0303336 A1
(43) Pub. Date: Sep. 12, 2024

(54) DYNAMIC SECURITY FOR FABRIC NETWORKS

(71) Applicant: Cisco Technology, Inc., San Jose, CA (US)

(72) Inventors: Deepthi Tammireddy, Dublin, CA (US); Shilpa Avinash Sodani, Dublin, CA (US); Vishnuprasad Raghavan, Sammamish, WA (US); Hongqing Li, Sunnyvale, CA (US)

(73) Assignee: Cisco Technology, Inc., San Jose, CA (US)

(21) Appl. No.: 18/180,807

(22) Filed: Mar. 8, 2023

(51) Int. Cl. G06F 21/56; G06F 21/55; H04L 9/40

(52) U.S. Cl. CPC G06F 21/566; G06F 21/552; H04L 63/1408; H04L 63/20

(57) ABSTRACT

A method of protecting networks may include detecting a compromised computing device associated with a security event generated by a unified security policy from a plurality of sites within a network. A context of the compromised computing device may be extracted. The context may be propagated to a controller. The method may further include fetching from an identity services engine (ISE), user identity associated with the compromised computing device, and provisioning the controller with a dynamic list and a data policy matching the dynamic list. The method may also include advertising the dynamic list and the data policy to at least one of the plurality of sites.

### TECHNICAL FIELD

The present disclosure relates generally to computing network security. Specifically, the present disclosure relates to systems and methods for dynamically securing fabric networks by learning, proactively distributing, and protecting remote sites from compromised user computing devices and malicious server computing devices.

### BACKGROUND

Computing networks allow users and organizations to share computing resources and transmit data. Because these computing resources and transmitted data likely contain private and confidential information, the computing networks should be secured from any and all types of security threats.

Compromised user computing devices and malicious server computing devices may pose a significant threat to network security. Security services such as firewalls, intrusion detection systems (IDS), intrusion prevention systems (IPS), advanced malware protection (AMP), and other advanced security inspection systems and software packages may be able to detect security threats related to the compromised user computing devices and malicious server computing devices. The compromised user computing devices and malicious server computing devices may be identified by an Internet Protocol (IP) address, a port (e.g., a number assigned to uniquely identify a connection endpoint and to direct data to a specific service), an identification of software and/or hardware (e.g., an application name), a security group tag (SGT) (e.g., a unique 16 bit tag indicating privileges of the source within the entire network), and combinations thereof.

A computing network may include a number of branch sites or remote sites. One or more of these remote sites may include one or more compromised user computing devices or malicious server computing devices that can affect other computing devices at the same remote site as well as other computing devices located at other remote sites communicatively coupled via an intra-site network. For example, in instances where a first compromised user computing device is detected, other remote sites in, for example, a software-defined wide area network (SD-WAN) fabric may still access the first compromised user computing device. Further, the first compromised user computing device may still have access to sensitive applications and data residing on other remote sites.

In another instance related to malicious server computing devices, the server computing device may have become compromised and may have begun to download malware to a number of computing devices in the network and at any remote sites communicatively coupled to the network. A user computing device may access this malicious server computing device, and the advanced security inspection systems may detect the malicious activity of the malicious server computing device. However, the malicious server computing device may not be blocked from remote sites and computing devices in those remote sites from accessing the malicious server computing device via the SD-WAN fabric. In the above two scenarios, a security finding may not be distributed to other remote sites within the SD-WAN fabric network, resulting in the security of those remote sites being compromised.

Further, in order to block the compromised user computing devices and malicious server computing devices, an administrator or other individual may be required to manually configure a security service on all remote sites. Thus, in the above examples and systems, there may not exist a way to protect the remote sited within the SD-WAN fabric from malicious attacks in an autonomous manner which may result in malicious attacks infiltrating into one or more of the remote sites.

Static firewall rules may be matched with a user where the user is identified by a username, SGT, TAG, IP address, block, and combinations thereof. However, this matching and identification requires manual intervention by an administrator, customer, or other individual to collect the user context information and feed that information into the configuration of the static firewall rules.

Other security vendors may detect compromised user computing devices and/or malicious server computing devices and periodically push information regarding the compromised user computing devices and/or malicious server computing devices to a number of firewalls within the network. However, the pushing of information regarding the compromised user computing devices and/or malicious server computing devices will not work in, for example, an SDWAN deployment since not all remote sites include a security firewall. Further, these solutions may be tied more to IP filtering and may not work for scenarios in which a user may be identified by context other than an IP address.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of a network that utilizes a network protection services, according to an example of the principles described herein.

FIG. 2 is a component diagram of example components of a controller including network protection services, according to an example of the principles described herein.

FIG. 3 is a component diagram of example components of an identity services engine (ISE) including network protection services, according to an example of the principles described herein.

FIG. 4 is a component diagram of example components of a remote site including network protection services, according to an example of the principles described herein.

FIG. 5 illustrates a flow diagram of an example method of protecting a network from compromised computing devices, according to an example of the principles described herein.

FIG. 6 illustrates a flow diagram of an example method of protecting a network from compromised computing devices, according to an example of the principles described herein.

FIG. 7 illustrates a computing system diagram illustrating a configuration for a data center that may be utilized to implement aspects of the technologies disclosed herein.

FIG. 8 illustrates a computer architecture diagram showing an example computer hardware architecture for implementing a computing device that may be utilized to implement aspects of the various technologies presented herein.

### DESCRIPTION OF EXAMPLE EMBODIMENTS

The system and methods described herein provide for dynamically securing an SD-WAN fabric network from newly-detected security threats involving compromised user computing devices and/or malicious server computing devices. These threats may be isolated from the SD-WAN fabric network via the present systems and methods. Security services on a remote site may detect a compromised user computing devices and/or malicious server computing devices and relay information regarding the compromised user computing devices and/or malicious server computing devices to a controller. The controller may propagate data defining the compromised user computing devices and/or malicious server computing devices to at least one other remote site within the SD-WAN fabric network. The compromised user computing devices and/or malicious server computing devices may automatically blocked and/or quarantined using SD-WAN policies pre-crafted by the controller

### Overview

In the examples described herein, a controller may be used to dynamically secure computing devices within a fabric network and existing in different remote sites from any compromised user computing devices and malicious server computing devices that may exists within the overall network. The controller may also utilize an identity services engine (ISE) to assist in the identification of compromised computing devices. The systems and methods described herein provide for connected security in the fabric network 108 (e.g., an SDWAN fabric network). Further, automatic security learnings from each remote site may be obtained that may be proactively propagated to other remote sites. A compromised user computing device and context associated with the compromised user computing device may be identified from a security threat event and may be dynamically relayed to the controller. Further, the controller may perform selective distribution of threat to the remote sites based on user-identity, geo-location of the compromised user computing device, location of the compromised remote site, other parameters, and combinations thereof. User intervention throughout the automated processes described herein is unnecessary when a new user computing device is added to the network including the fabric network.

Further, with the present systems and methods, manual configuration change in policies is not required in order to accommodate matched for new user computing devices. The controller may handle changes to the IP addresses of a compromised user computing device and/or a malicious server computing device using communications with the ISE in order to seamlessly propagate these changes to relevant or appropriate remote sites. Further, the controller may track malicious activity on the remote sites over a period of time and/or for a percentage of user computing devices infected at the remote site. Still further, the controller may protect the remote sites from compromising security threats by auto-installing policies to withdraw routes and/or TLOC.

The present systems and methods may provide a collective visualization of the security posture of the fabric network 108 and the network as a whole. Further, improved use of available resources across the network including the fabric network may be realized. Without the learning and distribution features of the present systems and methods, the security services must spend additional cycles to detect security threats. Thus, the present systems and methods saves overall turnaround time for security threat detection and remediation. Further, for remote sites that do not have a firewall or other security tools where traffic may be steered for security inspection, the present systems and methods provide for detection of user computing devices at a remote site. This will conserve bandwidth within the fabric network.

Examples described herein provide a method of protecting networks. The method may include detecting a compromised computing device associated with a security event generated by a unified security policy from a plurality of sites within a network. A context of the compromised computing device may be extracted. The context may be propagated to a controller. The method may further include fetching from an identity services engine (ISE), user identity associated with the compromised computing device, and provisioning the controller with a dynamic list and a data policy matching the dynamic list. The method may also include advertising the dynamic list and the data policy to at least one of the plurality of sites.

The method may further include notifying the ISE of the compromised computing device, and registering, with the ISE, changes to an IP address for the compromised computing device. Based at least in part on the IP address of the compromised computing device changing to a new IP address, the ISE may update the controller with the new IP address and may update the dynamic list to include the new IP address.

The dynamic list may include, for example, an IP address, a port, an application name, a security group tag (SGT), a username, or combinations thereof that are associated with the compromised computing device. The data policy may include pre-crafted rules matching the dynamic list, and at least one action to take based on the pre-crafted rules.

The method may further include tracking malicious activity metrics for the plurality of sites based on at least one parameter, wherein the at least one parameter comprises activity over a period of time, percentage of infected computing devices at the plurality of sites, and combinations thereof. The user identity may include a username associated with the compromised computing device, a geolocation of the compromised computing device, a quarantine virtual private network (VPN) associated with the compromised computing device, and combinations thereof. The context is advertised to the controller via overlay management protocol (OMP). Advertising the dynamic list and the data policy to at least one of the plurality of sites may be based on a geolocation of the compromised computing device, based on a site list, based on user-defined criteria, and combinations thereof.

Examples described herein also provide a non-transitory computer-readable medium storing instructions that, when executed, causes a processor to perform operations. The operations may include detecting a compromised computing device associated with a security event generated by a unified security policy from a plurality of sites within a network, and extracting a context of the compromised computing device, propagating the context to a controller. The operations may further include fetching from an identity services engine (ISE), user identity associated with the compromised computing device, and provisioning the controller with a dynamic list and a data policy matching the dynamic list. The operations may further include advertising the dynamic list and the data policy to at least one of the plurality of sites.

The operations further include notifying the ISE of the compromised computing device, and registering, with the ISE, changes to an IP address for the compromised computing device. Based at least in part on the IP address of the compromised computing device changing to a new IP address, the operations may further include updating the controller with the new IP address and updating the dynamic list to include the new IP address.

The dynamic list may include an IP address, a port, an application name, a security group tag (SGT), a username, or combinations thereof that are associated with the compromised computing device. The data policy may include pre-crafted rules matching the dynamic list, and at least one action to take based on the pre-crafted rules. The operations may further include tracking malicious activity metrics for the plurality of sites based on at least one parameter. The at least one parameter comprises activity over a period of time, percentage of infected computing devices at the plurality of sites, or combinations thereof. Advertising the dynamic list and the data policy to at least one of the plurality of sites is based on a geolocation of the compromised computing device, based on a site list, based on user-defined criteria, and combinations thereof.

Examples described herein also provide a controller including a processor and a non-transitory computer-readable media storing instructions that, when executed by the processor, causes the processor to perform operations. The operations may include receiving a context of a compromised computing device associated with a security event generated by a unified security policy from a plurality of sites within a network, and fetching from an identity services engine (ISE), user identity associated with the compromised computing device. The operations may further include provisioning a dynamic list and a data policy matching the dynamic list and advertising the dynamic list and the data policy to at least one of the plurality of sites.

The operations may further include notifying the ISE of the compromised computing device, and registering, with the ISE, changes to an IP address for the compromised computing device. The operations may further include, based at least in part on the IP address of the compromised computing device changing to a new IP address, updating the controller with the new IP address, and updating the dynamic list to include the new IP address.

The data policy may include pre-crafted rules matching the dynamic list, and at least one action to take based on the pre-crafted rules. The operations may further include tracking malicious activity metrics for the plurality of sites based on at least one parameter, wherein the at least one parameter comprises activity over a period of time, percentage of infected computing devices at the plurality of sites, and combinations thereof. Advertising the dynamic list and the data policy to at least one of the plurality of sites is based on a geolocation of the compromised computing device, based on a site list, based on user-defined criteria, or combinations thereof.

Additionally, the techniques described in this disclosure may be performed as a method and/or by a system having non-transitory computer-readable media storing computer-executable instructions that, when executed by one or more processors, performs the techniques described above.

### Example Embodiments

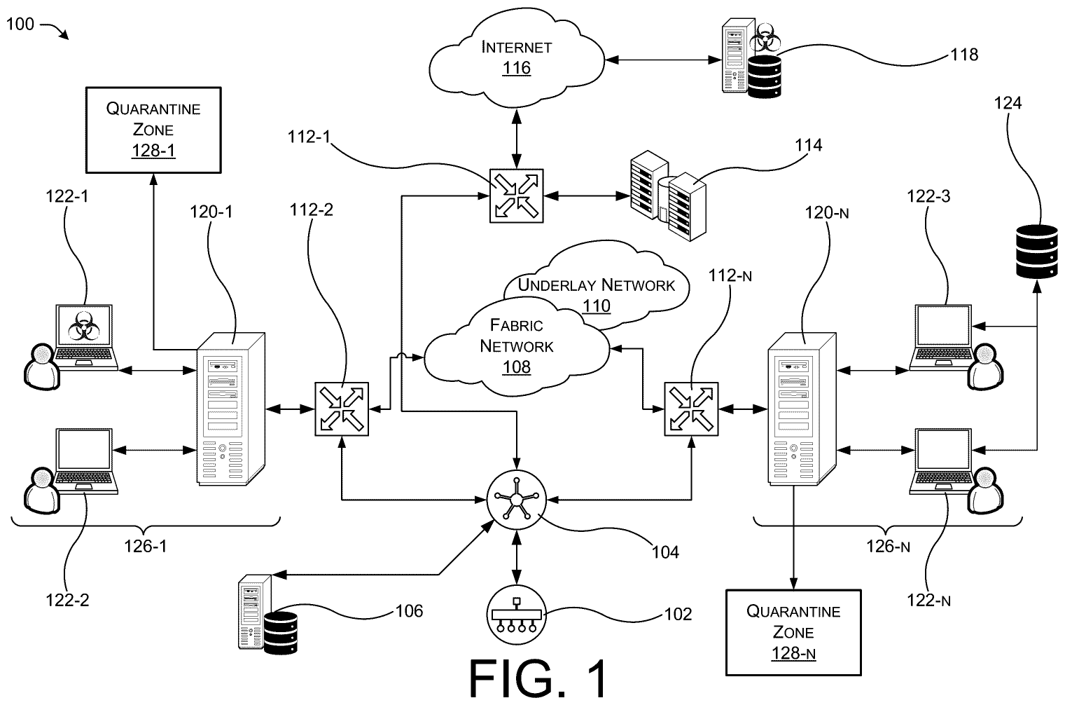

Turning now to the figures, FIG. 1 illustrates a system-architecture diagram of a network 100 that utilizes a network protection services, according to an example of the principles described herein. The network 100 may include an orchestrator 102, a controller 104, a fabric network 108 and an underlay network 110 associated with the fabric network 108. The network 100 may include one or more physical or virtual wide area network (WAN) management systems 102 (hereinafter referred to as management system 102) and controllers 104 (hereinafter referred to as controller 104). In one example, the management system 102 may include a wide area network (WAN) management system and the controller 104 may include a WAN fabric controller. Further, in one example, the management system 102 and/or the controller 104 may be configured to operate within a software-defined wide area network (SD-WAN) fabric such as the fabric network 108 depicted in FIG. 1. In one example, the fabric network 108 may include a wireless broadband-enabled network such as, for example, a long-term evolution (LTE) standard network. Although a plurality of management systems 102 and/or controllers 104 may be implemented as distinct network appliances, in one example, the management system 102, the controller 104, and/or the other network devices deployed in the network 100 may be integrated in various combinations. For example, one or more management systems 102 may run on the same physical servers as one or more controllers 104, other network devices deployed in the network 100, and so on. In one example, the management systems 102 may include a Cisco® vManage®-enabled orchestrator computing device.

The management system 102 may be responsible for central configuration and monitoring of the fabric network 108, among other tasks, and may include one or more physical or virtual management systems 102 as mentioned above. In one example, the management system 102 may provide a dashboard to operate as a visual window for users into the network 100 and allow for the configuration and the administration of the controller 104 and other network devices deployed in the network 100. In one example, the management system 102 may be situated in a centralized location, such as, for example, an organizational data center, co-location facility, cloud service provider network, and the like.

The management system 102 may also store certificate credentials and create and store configuration information for the controller 104 and other network devices deployed in the network 100. As network devices of the overlay network (e.g., the fabric network 108) come online, they may request their certificates and configuration information from the management system 102, and the management system 102 may push the certificates and configuration information to the requesting network devices. For cloud-based network devices, the management system 102 may also sign certificates and generate bootstrap configuration information and decommission devices. In one example, the management system 102 may include one or more physical or virtual Cisco® SD-WAN vManage® Network Management Systems.

The controller 104 may build and maintain the topology of the fabric network 108 and make decisions on where traffic flows. In one example, the controller 104 may include a Cisco® vSmart® control plane-enabled computing device. Further, the controller 104 may work with an orchestrator and the management system 102 to authenticate and register the management system 102, the controller 104, and other network devices deployed in the network 100, and to coordinate connectivity among the devices. The controller 104 may include one or more physical or virtual fabric controllers and may oversee a control plane, establishing, adjusting, and maintaining the connections that form the fabric network 108. Some of the functions and features implemented by the controller 104 include secure control plane connectivity, overlay management protocol (OMP), authentication, key reflection and rekeying, policy, and multiple configuration modes, among others.

An individual controller 104 may establish and maintain an individual secure control plane connection (e.g., DTLS, TLS, etc.) with each of a number of other controllers 104 of the overlay network as well each device within the fabric network 108. In one example deployment with multiple controllers 104, a single controller 104 may have an individual secure connection to each router of a subset of all of the computing devices of the fabric network 108 for load-balancing purposes. The individual secure connection may carry an encrypted payload between the individual controller 104 and another controller and between the controller and the individual computing device. This payload may include route information for the controller 104 to determine the network topology, calculate the best routes to network destinations, and distribute the route information to the computing devices under the administrative control of the controller 104 (e.g., authenticated and registered by the controller 104). The secure connection between an individual controller 104 and an individual computing device may be a persistent connection.

OMP is a routing protocol similar to BGP in some respects that may be used to manage the fabric network 108. OMP may run inside the secure control plane connections, and carry the routes, next hops, keys, policy information, and the like, to establish and maintain the fabric network 108. OMP may run between the controller 104 and the computing devices within the fabric network 108 over the secure connections, and, in some cases, may carry only control plane information. The controller 104 may process the routes and advertise reachability information learned from these routes to other controllers and the computing devices forming the overlay network that is the fabric network 108.

OMP peering may be initiated for headend devices 120, edge devices 112, user computing devices 122, and other devices when these devices join the network 100. During OMP peering, the two endpoints of OMP peering may include the system IPs of, for example, the edge devices 112 and the controller 104 using all available control connections (e.g., all available IP paths) therebetween. OMP protocol may operate in the overlay network (e.g., the fabric network 108) including the controller 104 and the edge devices 112. The edge devices 112 may peer only with the controller 104 and may not form any control-plane relationship among themselves over the fabric network 108. With these architectural features along with the fact that the edge devices 112 do not need to form routing adjacencies between themselves and do not have to respond to an excessive number of routing updates, the OMP protocol more manageable, secure, and more efficient compared to other routing architectures, and especially so in large-scale deployments.

In one example, to provide redundancy and high availability, the network 100 may include multiple controllers 104. To ensure that OMP routes remain synchronized, multiple controllers 104 may have the same configuration for policy and OMP. The configuration for device-specific information, such as interface locations and addresses, system identifiers, host names, and the like, may be different. In a deployment with redundant controllers 104, the management system 102 and/or an orchestrator may identify an individual controller 104 to other controllers, and coordinate which of the controllers and which of the computing devices within the fabric network 108 may accept connections to one another. Different computing devices in the same domain may connect to different controllers 104 for load balancing purposes. If one controller 104 becomes unavailable, the other controllers may automatically and immediately sustain the functioning of the overlay network. In one example, one or more Cisco® SD-WAN vSmart® controllers may operate as the controller 104.

The fabric network 108 may include any number of interconnected nodes such as user computing devices, server computing devices, routers, switches, edge devices, and the like. The nodes of the fabric network 108 may include processor(s), memory, and/or peripherals as well as links (e.g., functional connections between nodes). The fabric network 108 may be associated with an underlay network 110. Nodes in the overlay network (e.g., the fabric network 108) may be connected by virtual or logical links, each of which corresponds to a path through a number of physical links in the underlying network 110.

A number of edge devices 112-1, 112-2 . . . 112-N, where N is any integer greater than or equal to 1 (collectively referred to herein as edge device(s) 112 unless specifically addressed otherwise) may be coupled to the fabric network 108. The edge devices 112 may include any device to which a number of remote sites 126-1 . . . 126-N, where N is any integer greater than or equal to 1 (collectively referred to herein as remote site(s) 126 unless specifically addressed otherwise) may be coupled to and communicate via the fabric network 108.

Further, a first edge device 112-1 may be coupled to a data center 114. The data center may include any number of computer systems and associated components that provide computing resources such as, for example, processing resources, data storage resources, power supplies, data communication connections, environmental controls, security devices, other computing resources, and redundancies thereof. The first edge device 112-1 may also provide access to the Internet 116 and/or other networks. As depicted in FIG. 1, a command and control (C&C) server 118 may also be coupled to the fabric network 108 via the Internet 116 and the first edge device 112-1. As described in more detail herein, the C&C server 118 may include any malicious or compromised server computing device that may increase security risks to computing devices within the remote sites 126. The present systems and methods seek to eliminate the risk the C&C server 118 may have to the computing devices within the remote sites 126.

The remote sites 126 may include a first remote site 126-1. The first remote site 126-1 may be coupled to the fabric network 108 via an N^{th} edge device 112-N. The first remote site 126-1 may include a first headend device 120-1 to provide remote access for a number of user computing devices 122-1, 122-2, 122-3, . . . 122-N, where N is any integer greater than or equal to 1 (collectively referred to herein as user computing device(s) 122 unless specifically addressed otherwise), and, specifically, a first user computing device 122-1 and a second user computing device 122-2. Similarly, an N^{th} remote site 126-N. The N^{th} remote site 126-N may be coupled to the fabric network 108 via a third edge device 112-N. The N^{th} remote site 126-N may include an N^{th} headend device 120-N to provide remote access for a number of user computing devices 122 such as a third user computing device 122-3 and an N^{th} user computing device 122-N. The N^{th} remote site 126-N may be coupled to the fabric network 108 via an N^{th} edge device 112-N. In one example, the management system 102 may be used to manage the remote sites 126 including the headend devices 120. Further, in one example, the user computing devices 122 within the remote sites 126 such as the N^{th} remote site 126-N may include other computing devices and systems such as, for example, a structured query language (SQL) Database (DB) (SQL DB) 124 that may be compromised or may be threatened by another compromised computing device. Thus, it is important to protect a wide variety of computing devices within the remote sites 126 and the fabric network 108.

As described in more detail herein, one or more of the user computing devices 122 may be infected with a virus or otherwise compromised such that security risks to computing devices within the remote sites 126 may increase. In the example of FIG. 1, the first user computing device 122-1 is depicted as being compromised. As used in the present specification and in the appended claims, the term “compromised” is meant to be understood broadly as having one or more security risks associated therewith. For example, a compromised user computing device 122 may be compromised by hardware and/or software that results in any offensive maneuver targeting computer information systems, computer networks, infrastructures, or personal computer devices. The compromises may include, for example, active attacks, passive attacks, computer and network surveillance, wiretapping, fiber tapping, port scanning, idle scanning, keystroke logging, data scraping, backdoor attacks, denial-of-service (DOS) attacks, spoofing attacks, mixed threat attacks, man-in-the-middle attacks, man-in-the-browser attacks, address resolution protocol (ARP) poisoning attacks, ping flood attacks, ping of death attacks, Smurf attacks, buffer overflow attacks, heap overflow attacks, stack overflow attacks, format string attacks, supply chain attacks, social engineering attacks, exploit attacks, viruses, worms, trojan horses, semantic attacks, other types of cyber attacks, and combinations thereof. Those computing devices within the remote sites 126 that may be subjected to the increase in security risk may include, for example, the edge devices 112, the headend devices 120, the user computing devices 122 and other devices within the fabric network 108. The present systems and methods seek to eliminate the risk of a compromised user computing devices 122 within the remote sites 126.

The network 100 may further include an identity services engine (ISE) 106. The ISE 106 may serve as a security policy management platform that provides secure network access to end users and devices such as the edge devices 112, the headend devices 120, the user computing devices 122 and other devices within the fabric network 108. For example, the ISE 106 may enable the creation and enforcement of security and access policies for the headend devices 120 and the user computing devices 122 that are connected to an organization's routers and switches such as the edge devices 112. The ISE 106 may be available as an appliance or software that may run on a cloud service and/or virtually and may include a number of nodes such as a policy administration node to enable administrators to log into and configure policies and system-related configurations and push changes out to policy services nodes. The nodes of the ISE 106 may further include a monitoring node configured to collect logs and generate reports regarding event that occur within the topology of the network 100. A policy service node may also be included within the ISE 106 to provide network access, provisioning, profiling, posture, and guest access services. Further, the nodes of the ISE 106 may include a platform exchange grid (pxGrid) node to exchange context-based sensitive data from an ISE session directory with other ISE network systems and products and to enable the ISE 106 to transfer data to other software. When a device connects to the fabric network 108, the ISE 106 may verify who the user is, along with the type of device they are using, the time and location of the request from the user and the access method used. Once the ISE 106 determines the request is legitimate, the user may be granted network access.

The management systems 102 and controller 104 in conjunction with the ISE 106 protect the network by dynamically securing the fabric network 108 (e.g., SD-WAN fabric network) by learning, proactively distributing, and protecting the remote sites 126 from compromised users (e.g., the first user computing device 122-1) and malicious servers (e.g., the C&C server 118). The remote sites 126 may intercept any security events that are generated by a unified security policy executed on, for example, the headend devices 120. Thus, the headend devices 120 may detect a compromised computing device (e.g., the first user computing device 122-1 and/or the C&C server 118) from a plurality of the remote sites 126 within the network 100 and, specifically, and computing device coupled to the fabric network 108. The detection of the compromised computing device may be in reference to a new security threat from the user computing device 122 and/or the C&C server 118, the detection of a compromised user computing device 122 or the C&C server 118, other detected security compromises, and combinations thereof.

The headend devices 120 of the remote sites 126 may extract a context of the compromised user computing device 122 and/or the malicious C&C server 118 associated with the detection of the security threat. The context of the compromised user computing device 122 and/or the malicious C&C server 118 may include any data associated with or defining the compromise or malicious threat and may be referred to herein as a newly detected threat context. For example, the context may include an IP address, a port (e.g., a number assigned to uniquely identify a connection endpoint and to direct data to a specific service), an identification of software and/or hardware (e.g., an application name), a security group tag (SGT) (e.g., a unique 16 bit tag indicating privileges of the source within the entire network), a username, a geolocation, an identification of a remote site 126 associated with the compromised user computing device 122 and/or the malicious C&C server 118, an identification of an edge device 112 associated with the compromised user computing device 122 and/or the malicious C&C server 118, an identification of a headend device 120 associated with the compromised user computing device 122 and/or the malicious C&C server 118, an identification of a the compromise or malicious threat, a type of the compromise or malicious threat, characteristic the compromise or malicious threat, and combinations thereof.

Once obtaining the context, the headend devices 120 of the remote sites 126 may propagate or otherwise transmit the context to the controller 104 where the controller 104 may begin to proactively distribute the security learnings into the fabric network 108 based at least in part on the context received from the headend devices 120. In one example, the context may be advertised to the controller 104 via overlay management protocol (OMP). Further, in one example, advertising the dynamic list and the data policy to at least one of the plurality of sites may be based on a geolocation of the compromised user computing device 122 and/or the malicious C&C server 118, based on a site list, based on user-defined criteria, and combinations thereof.

The controller 104 may utilize the ISE 106 to assist in the proactive distribution of the security learnings. In one example, the controller 104 may fetch from the ISE 106 a user identity associated with the compromised user computing device 122 and/or the malicious C&C server 118. In one example, the user identity may include a username associated with the compromised user computing device 122 and/or the malicious C&C server 118, a geolocation of the compromised user computing device 122 and/or the malicious C&C server 118, a quarantine virtual private network (VPN) associated with the compromised user computing device 122 and/or the malicious C&C server 118, and combinations thereof.

In one example, the controller 104 may be provisioned and/or pre-provisioned with at least one dynamic list and at least one data policy matching the dynamic list. The dynamic list may include an IP address, a port, an SGT, and combinations thereof associated with the user computing devices 122, the headend devices 120, the edge devices 112, other computing devices within the fabric network 108, and combinations thereof. The data policy matching the dynamic list may include a number of pre-crafted rules matching the dynamic list, and at least one action to take based on the pre-crafted rules. As described in more detail herein, the controller 104 may advertise the dynamic list and the data policy to at least one of the plurality of the remote sites 126.

The controller 104 may notify the ISE 106 of the existence of the compromised user computing device 122 and/or the malicious C&C server 118. The controller 104 may instruct the ISE 106 to register, with the ISE 106, changes to an IP address for the compromised user computing device 122 and/or the malicious C&C server 118. In one example, the ISE 106 may perform this registration with or without instructions from the controller 104. Based at least in part on a change to the IP address of the compromised user computing device 122 and/or the malicious C&C server 118 to a new IP address, the ISE 106 may update the controller 104 with the new IP address. Further, the ISE 106 may update the dynamic list to include the new IP address.

The dynamic lists described herein may include an IP address of the compromised user computing device 122 and/or the malicious C&C server 118, a port at which one or more computing devices within the fabric network 108 may couple to the compromised user computing device 122 and/or the malicious C&C server 118, an application name executed on the compromised user computing device 122 and/or the malicious C&C server 118 that is associated with the security issue, a security group tag (SGT) that specifies the privileges of a traffic source (e.g., the compromised user computing device 122 and/or the malicious C&C server 118) within the fabric network 108, a username associated with the compromised user computing device 122 and/or the malicious C&C server 118, and combinations thereof that are associated with the compromised computing device.

The at least one data policy that matches the dynamic list may include at least one pre-crafted rule matching the dynamic list. The pre-crafted rules may be generated by an administrator or other user, may be generated through machine learning or artificial intelligence (AI), may be preinstalled on the controller 104 or other device within the fabric network 108, and combinations thereof.

Further, the at least one data policy that matches the dynamic list may include at least one action to take based on the pre-crafted rules. The actions may include any instructions or processes that addresses the traffic from the compromised user computing device 122 and/or the malicious C&C server 118 or address the handling of the compromised user computing device 122 and/or the malicious C&C server 118 themselves. For example, the actions may include redirecting traffic from the compromised user computing device 122 and/or the malicious C&C server 118 to a quarantine zone (e.g., quarantining the traffic). Further, the actions may include blocking the compromised user computing device 122 and/or the malicious C&C server 118 from communicating with any device in the fabric network 108, the remote sites 126, the controller 104, the ISE 106, the management system 102, the underlay network 110, the edge devices 112, the data center 114, or other devices within the network 100. Still further, the actions may include isolating the compromised user computing device 122 and/or the malicious C&C server 118 from communicating with any device in the fabric network 108, the remote sites 126, the controller 104, the ISE 106, the management system 102, the underlay network 110, the edge devices 112, the data center 114, or other devices within the network 100. Still further, the action may include instructing any device in the network 100 to drop any traffic received from compromised user computing device 122 and/or the malicious C&C server 118.

In one example, every remote site 126 and their respective headend devices 120 may be configured with a quarantine zone 128-1 . . . 128-N, where N is any integer greater than or equal to 1 (collectively referred to herein as quarantine zone(s) 128 unless specifically addressed otherwise). The quarantine zones 128 may include any virtual or physical storage device to which traffic may be forwarded and isolated from the remaining network 100. In one example, the quarantine zones 128 may be included as a portion of the headend devices 120 or separate from the headend devices 120. The headend devices 120 and their quarantine zones 128 may be represented by a virtual routing and forwarding (VRF) identification (ID) where incoming packets from the compromised user computing device 122 and/or the malicious C&C server 118 and received at the headend devices 120 are analyzed by an input flow monitoring component that collects the VRF ID from the incoming packets as a key field. This key field may be used to then determine whether the incoming packets are to be quarantined based on instructions obtained from the controller 104 and the ISE 106

The headend devices 120 and their quarantine zones 128 may also be represented by a next-hop ID. The next-hop ID may identify an IP address of an adjacent router or device with layer-2 connectivity (e.g., the edge devices 112, user computing devices 122, and other devices within the network 100) to the managed device (e.g., the headend devices 120). As the headend devices 120 utilize policy-based routing obtained from the controller 104 to forward data packets to a next hop device and that next-hop device becomes unreachable, the packets matching the policy will not reach their destination and will, instead, be quarantined in the quarantine zone 128.

In one example, the controller 104, the ISE 106, and/or other devices within the network 100 may track malicious activity metrics for the plurality of remote sites 126 based on at least one parameter. The at least one parameter may include activity over a period of time, percentage of infected computing devices at the plurality of remote sites 126, and combinations thereof.

Once the controller 104 learns of compromised users or security threats within the network 100 by analyzing activity within the remote sites 126, the controller 104 may engage in proactively distributing security learnings into the fabric network 108. The controller 104 may be provisioned and/or pre-provisioned with the dynamic lists described herein including the IP addresses, ports, application names, SGTs, and combinations thereof. As described herein, the controller 104 may also include the data policies including pre-crafted rules that match the dynamic rules.

The controller 104, via a connection with the ISE 106, may fetch the user information, the username associated with the compromised user computing device 122 and/or the malicious C&C server 118, the geolocation of the compromised user computing device 122 and/or the malicious C&C server 118, the quarantine virtual private network (VPN) associated with the compromised user computing device 122 and/or the malicious C&C server 118, and combinations thereof.

In one example, the controller 104 may create multiple dynamic lists and may selectively advertise the associated rules within the dynamic lists based on the geo-location of the user. For example, if the controller 104 determines that the first user computing device 122-1 is compromised as depicted in FIG. 1, may advertise the associated rules with the dynamic lists to, for example, the second user computing device 122-2, the first headend device 120-1, and/or the second edge device 112-2 since all three devices may be co-geolocated with the first user computing device 122-1.

The controller 104 may selectively advertise the associated rules within the dynamic lists based on a site list. The site list may include identification of at least one computing device located at a remote site 126 including user computing devices 122, headend devices 120, edge devices 112, other computing devices, and combinations thereof. For example, if the controller 104 determines that the first user computing device 122-1 is compromised as depicted in FIG. 1, may advertise the associated rules with the dynamic lists to, for example, the second user computing device 122-2, the first headend device 120-1, and/or the second edge device 112-2 if those computing devices are included on a site list. In one example, the site list may be created and maintained by the controller 104, may be provided by the management system 102 or other computing device, and combinations thereof.

The controller 104 may selectively advertise the associated rules within the dynamic lists based on customer criteria. In one example, the customer criteria may be defined by an administrator based on input from a customer or other user of the network 100. The customer criteria may include any parameter that identifies a computing device within the network 100 as being required to receive the advertisement from the controller 104. For example, if the controller 104 determines that the first user computing device 122-1 is compromised as depicted in FIG. 1, may advertise the associated rules with the dynamic lists to, for example, the second user computing device 122-2, the first headend device 120-1, and/or the second edge device 112-2 if those computing devices are identified by the customer criteria. In one example, the customer criteria may be created and maintained by the controller 104, may be provided by the management system 102 or other computing device, and combinations thereof.

Upon receiving data defining the security learnings with respect to the compromised user computing device 122 and/or the malicious C&C server 118 from the remote sites 126, the controller 104 may fetch user context from the ISE 106. As described herein, the user context may include the username associated with the compromised user computing device 122 and/or the malicious C&C server 118, the geolocation of the compromised user computing device 122 and/or the malicious C&C server 118, the quarantine virtual private network (VPN) associated with the compromised user computing device 122 and/or the malicious C&C server 118, and combinations thereof.

The controller 104 may notify the ISE 106 that a user computing device 122 may be compromised. For example, in FIG. 1, the first user computing device 122-1 may be identified as the compromised user computing device 122, and the controller 104 may notify the ISE 106 that the first user computing device 122-1 is compromised. Further, the controller 104 may register with the ISE 106 to obtain any IP address changes to the first user computing device 122-1 that may occur in order to allow the controller 104 to identify the first user computing device 122-1 should the IP address of the first user computing device 122-1 change such as if the first user computing device 122-1 were to disconnect from and reconnect to the network 100 or otherwise obtains a different IP address.

The controller 104 may further fetch data defining a site location of the user computing device 122 from an OMP peer context. In one example, this information is stored in and obtained from the ISE 106. In one example, this information is stored in the controller 104.

Once this data is collected by the controller 104, the controller 104 may update a number of dynamic lists. In one example, the controller 104 selects appropriate dynamic lists to update based on the original creation of the dynamic lists and the user information obtained from the ISE 106 as described herein. The IP addresses identifying the compromised user computing device 122 and/or the malicious C&C server 118 and associated with the dynamic lists may be automatically advertised to a number of the remote sites 126.

In one example, the compromised user computing device 122 and/or the malicious C&C server 118 may disconnect from the fabric network 108 (e.g., logs out) and then reconnect with the fabric network 108. In this example, the IP address associated with the compromised user computing device 122 and/or the malicious C&C server 118 may change, but the security threat associated with the compromised user computing device 122 and/or the malicious C&C server 118 may still remain. In this scenario, the ISE 106 may automatically detect the change in IP address of the compromised user computing device 122 and/or the malicious C&C server 118 and update the controller 104 with the new IP address(es). The controller 104 may delete any outdated IP address and update those outdated IP addresses with the new IP addresses. The new IP addresses may then be used to update the dynamic lists that correspond to the compromised user computing device 122 and/or the malicious C&C server 118.

As one of the remedial actions described herein, the compromised user computing device 122 and/or the malicious C&C server 118 may be blocked from the rest of the network 100 including the fabric network 108. At a point in the future, the compromised user computing device 122 and/or the malicious C&C server 118 may no longer be compromised or otherwise be a security threat to the network 100 or the fabric network 108. Therefore, in one example, in order to unblock the compromised user computing device 122 and/or the malicious C&C server 118, an administrator or other user may manually intervein and correct the security posture of the previously-compromised user computing device 122 and/or the previously-malicious C&C server 118. The ISE 106 may then notify the controller 104 regarding the change in status of the previously-compromised user computing device 122 and/or the previously-malicious C&C server 118, update the IP addresses from the dynamic lists including deleting the IP addresses from the dynamic lists if necessary.

As described herein, any IP addresses and other information associated with the compromised user computing device 122 and/or the malicious C&C server 118 may be detected dynamically and distributed through the dynamic lists and on to any and all remote sites 126. An example of the dynamic lists that are distributed may be as follows:

Examples of Dynamic Lists that are Distributed:

| dynamic-list INFECTED_USERS | |
|---|---|
| user-ip-list | $ip-address |

| | |
|---|---|
| sgt_tag_list | $sgt_tag_id |

| | |
|---|---|
| user_ip_port_list | $ip-address && $port |
| user_app | $ip-address && $app-list |

| dynamic-list MAICIOUS_SERVERS_ASIA_PACIFIC | |
|---|---|
| server_ip-list | $ip-address |

| dynamic-list INFECTED_USERS_AMERICAS | |
|---|---|
| user-ip-list | $ip-address |

| | |
|---|---|
| sgt_tag_list | $sgt_tag_id |

| user_ip_port_list | $ip-address && $port |
|---|---|
| user_app | $ip-address && $app-list |
| dynamic-list INFECTED_USERS_SITE_LIST_1000 | |
| user-ip-list | $ip-address |
| sgt_tag_list | $sgt_tag_id |
| user_ip_port_list | $ip-address && $port |
| user_app | $ip-address && $app-list |

In the example of the distributed dynamic lists that are distributed, attributes designated by “$” may be updated dynamically after learning about the compromised user computing device 122 and/or the malicious C&C server 118.

Further, as described herein, the pre-crafted rules for handling the security threats from the compromised user computing device 122 and/or the malicious C&C server 118 may be crafted based on a data policy set up by an administrator or other user. An example of the pre-crafted rules may be as follows:

Pre-Crafted Rules for Handling Security Threats from Infected Users in a Data Policy

```
Policy dp1
  vpn-list vpn1
    sequence 1
      match
        source-users INFECTED_USERS
        destination-servers MALICIOUS_SERVERS
      action
        drop/quarantine/policy-based-actions
    sequence 2
      match
        destination-servers MALICIOUS_SERVERS
      action
        drop/quarantine/policy-based-actions
```

The fabric network 108 may be protected from the compromised user computing device 122 and/or the malicious C&C server 118 through automatic isolation of compromised users, auto-blocking of malicious servers, and site protection for the remote sites 126. As for the isolation of a compromised user computing device 122, the controller 104 and other devices within the network 100 may quarantine and/or drop any traffic coming from the compromised user computing device 122. As to a quarantine action, the traffic may be redirected to the quarantine zone 128. The remote sites 126 may be configured with the quarantine zones 128 and may be represented by the VRF ID and the next-hop ID as described above.

As to auto-blocking the malicious C&C server 118, a drop action or a secure internet gateway (SIG) action may be taken. The SIG may include the Cisco® Umbrella® cloud computing security product suite. With a SIG action, data packets may be sent to cloud security inspection handled at, for example, the controller 104 or wherever within the network 100 a SIG may be executed.

As to protection of the remote sites 126, the controller 104 may monitor malicious activity metrics learned per remote site 126 based on activity over a period of time (e.g., 24 hours) or a percentage of user computing devices 122 infected at a remote site 126. The controller 104 may include data or information defining a number of user computing devices 122 at each remote site 126 such as, for example, the first remote site 126-1. This data or information may be obtained from the ISE 106. Depending on the percentage of user computing devices 122 infected at a remote site 126 exceeding a threshold or a threshold level of malicious activity occurring at the remote site 126 over the period of time, the controller 104 may be provided with an option to automatically install control policies which withdraw routes and/or a transport locator (TLOC) representing an attachment point where the edge devices 112 may connect to a WAN transport. A TLOC may be uniquely identified by a tuple of three values including a system-IP address, a color, and an encapsulation. These control policies will eventually isolate the compromised remoted site 126 (e.g., the first remote site 126-1) from the fabric network 108. Further, none of the other remote sites 126 within the network 100 may reach the compromised remote site 126-1 (e.g., the first remote site 126-1). In subsequent monitoring instances of the malicious activity, if the activity metrics (e.g., activity of a period of time and/or the percentage of infected user computing devices 122 at the remote site 126), then the controller 104 may uninstall the control policy and routes and may again advertise to the previously-compromised remote site 126-1.

With the above description, the systems and methods described herein provide for connected security in the fabric network 108 (e.g., an SDWAN fabric network). Further, automatic security learnings from each remote site 126 may be obtained that may be proactively propagated to other remote sites 126. A compromised user computing device 122 and context associated with the compromised user computing device 122 may be identified from a security threat event and may be dynamically relayed to the controller 104. Further, the controller 104 may perform selective distribution of threat to the remote sites 126 based on user-identity, geo-location of the compromised user computing device 122, location of the compromised remote site 126, other parameters, and combinations thereof. User intervention throughout the automated processes described herein is unnecessary when a new user computing device 122 is added to the network 100 including the fabric network 108.

Further, with the present systems and methods, manual configuration change in policies is not required in order to accommodate matched for new user computing devices 122. The controller 104 may handle changes to the IP addresses of the compromised user computing device 122 and/or the malicious C&C server 118 using communications with the ISE 106 in order to seamlessly propagate these changes to relevant or appropriate remote sites 126. Further, the controller 104 may track malicious activity on the remote sites 126 over a period of time and/or for a percentage of user computing devices 122 infected at the remote site 126. Still further, the controller may protect the remote sites 126 from compromising security threats by auto-installing policies to withdraw routes and/or TLOC.

The present systems and methods may provide a collective visualization of the security posture of the fabric network 108 and the network 100 as a whole. Further, improved use of available resources across the network 100 including the fabric network 108 may be realized. Without the learning and distribution features of the present systems and methods, the security services must spend additional cycles to detect security threats. Thus, the present systems and methods saves overall turnaround time for security threat detection and remediation. Further, for remote sites 126 that do not have a firewall or other security tools where traffic may be steered for security inspection, the present systems and methods provide for detection of user computing devices 122 at a remote site 126. This will conserve bandwidth within the fabric network 108.

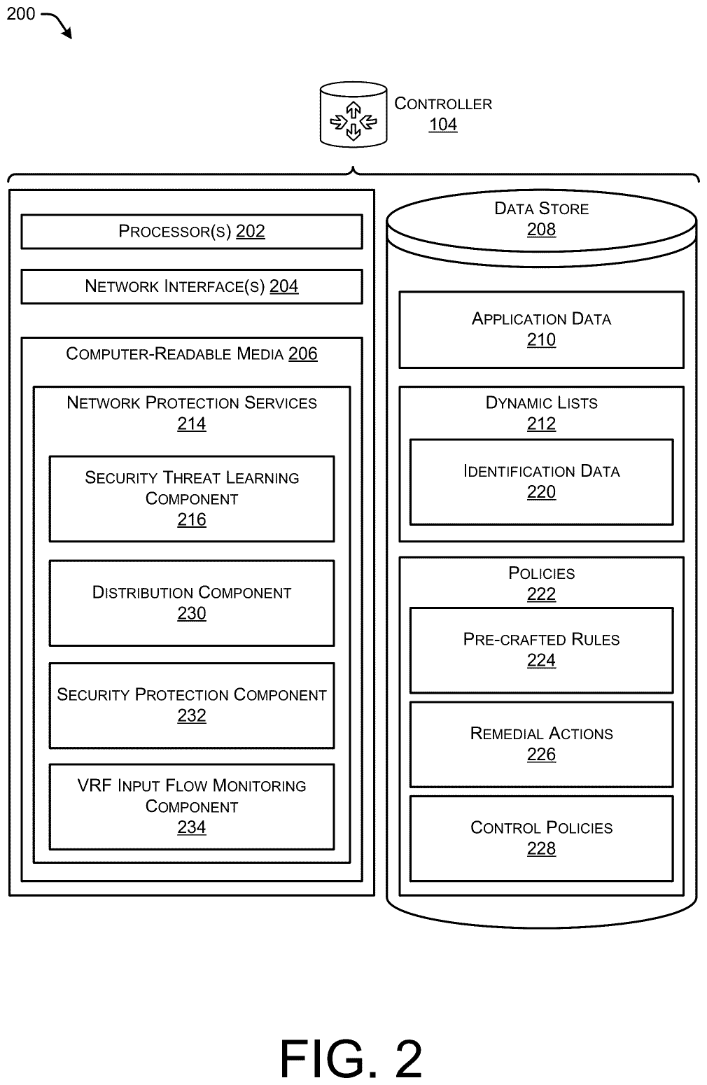

FIG. 2 is a component diagram 200 of example components of a controller 104 including network protection services, according to an example of the principles described herein. As illustrated, the controller 104 may include one or more hardware processor(s) 202 configured to execute one or more stored instructions. The processor(s) 202 may comprise one or more cores. Further, the controller 104 may include one or more network interfaces 204 configured to provide communications between the controller 104 and other devices, such as devices associated with the system architecture of FIG. 1 including the management system 102, the ISE 106, the fabric network 108, the underlay network 110, the edge devices 112, the data center 114, the internet 116 and computing devices therein, the C&C server 118, the headend devices 120, the user computing devices 122, the SQL DB 124, the quarantine zones 128 and any other devices within the network 100 including the fabric network 108, the underlay network 110, and/or other systems or devices associated with the controller 104 and/or remote from the controller 104. The network interfaces 204 may include devices configured to couple to personal area networks (PANs), wired and wireless local area networks (LANs), wired and wireless wide area networks (WANs), and so forth. For example, the network interfaces 204 may include devices compatible with the management system 102, the ISE 106, the fabric network 108, the underlay network 110, the edge devices 112, the data center 114, the internet 116 and computing devices therein, the C&C server 118, the headend devices 120, the user computing devices 122, the SQL DB 124, the quarantine zones 128 and any other devices within the network 100 including the fabric network 108, the underlay network 110 and/or other systems or devices associated with the controller 104.

The controller 104 may also include computer-readable media 206 that stores various executable components (e.g., software-based components, firmware-based components, etc.). In one example, the computer-readable media 206 may include, for example, working memory, random access memory (RAM), read only memory (ROM), and other forms of persistent, non-persistent, volatile, non-volatile, and other types of data storage. In addition to various components discussed herein, the computer-readable media 206 may further store components to implement functionality described herein. While not illustrated, the computer-readable media 206 may store one or more operating systems utilized to control the operation of the one or more devices that comprise the controller 104. According to one example, the operating system comprises the LINUX operating system. According to another example, the operating system(s) comprise the WINDOWS SERVER operating system from MICROSOFT Corporation of Redmond, Washington. According to further examples, the operating system(s) may comprise the UNIX operating system or one of its variants. It may be appreciated that other operating systems may also be utilized.

Additionally, the controller 104 may include a data store 208 which may comprise one, or multiple, repositories or other storage locations for persistently storing and managing collections of data such as databases, simple files, binary, and/or any other data. The data store 208 may include one or more storage locations that may be managed by one or more database management systems. The data store 208 may store, for example, application data 210 defining computer-executable code utilized by the processor 202 to execute the computer-readable media 206 including the network protection services 214.

Further, the data store 208 may store the dynamic lists 212. The dynamic lists 212 may include identification data 220 such as, for the example, the IP address(es), the port(s), the application name(s), the SGT data, and other data used to identify the compromised user computing device 122 or the C&C server 118.

Still further, the data store 208 may store the policies 222. The policies 222 may include the pre-crafted rules 224 matching the dynamic lists 212, and the remedial actions 226 that may be taken based on the pre-crafted rules. As described herein, the controller 104 may advertise the dynamic lists 212 and the policies 222 to at least one of the plurality of the remote sites 126. In one example, the policies 222 may further include control policies 228 that may be used to withdraw routes and/or a transport locator (TLOC) representing an attachment point where the edge devices 112 may connect to a WAN transport as described herein.

The computer-readable media 206 may store portions, or components, of the network protection services 214. For example, the network protection services 214 of the computer-readable media 206 may include a security threat learning component 216 to, when executed by the processor 202, identify any security threats within the network 100 including, for example, any compromised user computing devices 122 and/or the malicious C&C servers 118. The security threat learning component 216 may extract context from the compromised user computing devices 122 and/or the malicious C&C servers 118 which may be advertised to the controller 104 through OMP.

The network protection services 214 of the computer-readable media 206 may further include a distribution component 230 to, when executed by the processor 202, create, along with the ISE 106, the dynamic lists 212 and matching data policies 222 based at least in part on the context obtained from the compromised user computing devices 122 and/or the malicious C&C servers 118. The distribution component 230 may further update the dynamic lists as changes to IP addresses of the compromised user computing devices 122 and/or the malicious C&C servers 118 occur and interact with the ISE 106 to maintain up-to-date data associated with the compromised user computing devices 122 and/or the malicious C&C servers 118.

The network protection services 214 of the computer-readable media 206 may further include a security protection component 232 to, when executed by the processor 202, monitor metrics associated with malicious activity on the network 100, and, based on metrics being above or below a number of thresholds, installing or uninstalling control policies to withdrawn or reinstate routes and/or TLOCs learned from the compromised user computing devices 122 and/or the malicious C&C servers 118, isolating or reinstating remote sites 126, and take other actions as described herein.

The network protection services 214 of the computer-readable media 206 may further include a VRF input flow monitoring component 234 to, when executed by the processor 202, analyze incoming packets from the compromised user computing device 122 and/or the malicious C&C server 118 and received at the headend devices 120 and collect the VRF ID from the incoming packets as a key field. With the key field, the VRF input flow monitoring component 234 may be used to then determine whether the incoming packets are to be quarantined based on instructions obtained from the controller 104 and the ISE 106.

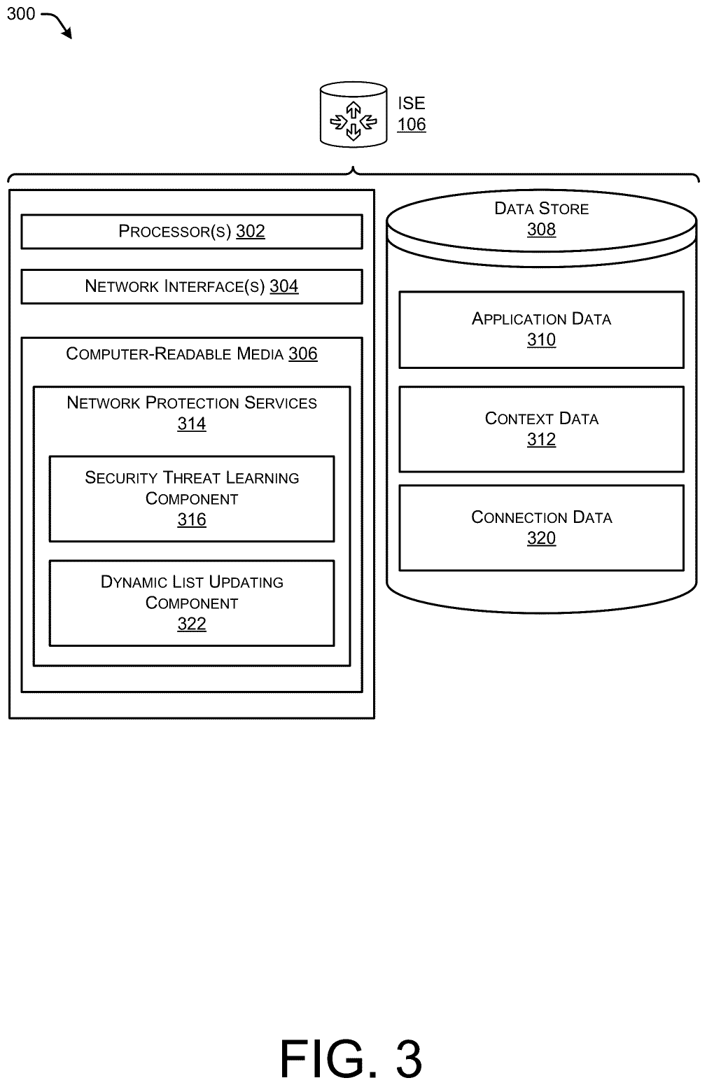

FIG. 3 is a component diagram 300 of example components of an identity services engine (ISE) 106 including network protection services, according to an example of the principles described herein. As illustrated, the ISE 106 may include one or more hardware processor(s) 302 configured to execute one or more stored instructions. The processor(s) 302 may comprise one or more cores. Further, the ISE 106 may include one or more network interfaces 304 configured to provide communications between the ISE 106 and other devices, such as devices associated with the system architecture of FIG. 1 including the management system 102, the controller 104, the fabric network 108, the underlay network 110, the edge devices 112, the data center 114, the internet 116 and computing devices therein, the C&C server 118, the headend devices 120, the user computing devices 122, the SQL DB 124, the quarantine zones 128, and/or other systems or devices associated with the ISE 106 and/or remote from the ISE 106. The network interfaces 304 may include devices configured to couple to personal area networks (PANs), wired and wireless local area networks (LANs), wired and wireless wide area networks (WANs), and so forth. For example, the network interfaces 304 may include devices compatible with the management system 102, the controller 104, the fabric network 108, the underlay network 110, the edge devices 112, the data center 114, the internet 116 and computing devices therein, the C&C server 118, the headend devices 120, the user computing devices 122, the SQL DB 124, the quarantine zones 128 and/or other systems or devices associated with the ISE 106.

The ISE 106 may also include computer-readable media 306 that stores various executable components (e.g., software-based components, firmware-based components, etc.). In one example, the computer-readable media 306 may include, for example, working memory, random access memory (RAM), read only memory (ROM), and other forms of persistent, non-persistent, volatile, non-volatile, and other types of data storage. In addition to various components discussed herein, the computer-readable media 306 may further store components to implement functionality described herein. While not illustrated, the computer-readable media 306 may store one or more operating systems utilized to control the operation of the one or more devices that comprise the ISE 106. According to one example, the operating system comprises the LINUX operating system. According to another example, the operating system(s) comprise the WINDOWS SERVER operating system from MICROSOFT Corporation of Redmond, Washington. According to further examples, the operating system(s) may comprise the UNIX operating system or one of its variants. It may be appreciated that other operating systems may also be utilized.

Additionally, the ISE 106 may include a data store 308 which may comprise one, or multiple, repositories or other storage locations for persistently storing and managing collections of data such as databases, simple files, binary, and/or any other data. The data store 308 may include one or more storage locations that may be managed by one or more database management systems. The data store 308 may store, for example, application data 310 defining computer-executable code utilized by the processor 302 to execute the computer-readable media 306 including the network protection services 314.

Further, the data store 308 may store context data 312. The context data 312 may include any data defining the context of the compromised user computing device 122 and/or the malicious C&C server 118 gathered at the headend devices 120 of the remote sites 126 including, for example, an IP address, a port, an application name, an SGT, a username, a geolocation, an identification of a remote site 126 associated with the compromised user computing device 122 and/or the malicious C&C server 118, an identification of an edge device 112 associated with the compromised user computing device 122 and/or the malicious C&C server 118, an identification of a headend device 120 associated with the compromised user computing device 122 and/or the malicious C&C server 118, an identification of a the compromise or malicious threat, a type of the compromise or malicious threat, characteristic the compromise or malicious threat, and combinations thereof.

Further, the data store 308 may store connection data 320. The connection data 320 may include any data defining the connection of one or more devices within the network 100 including the fabric network 108. For example, the connection data 320 may include any data defining the functioning of a security policy management platform that provides secure network access to end users and devices such as the edge devices 112, the headend devices 120, the user computing devices 122 and other devices within the fabric network 108, and combinations thereof.

The computer-readable media 306 may store portions, or components, of network protection services 314. For example, the network protection services 314 of the computer-readable media 306 may include a security threat learning component 316 functioning with the security threat learning component 216 of the controller 104. The security threat learning component 316, when executed by the processor 302, may identify any security threats within the network 100 including, for example, any compromised user computing devices 122 and/or the malicious C&C servers 118. The security threat learning component 316 may extract context from the compromised user computing devices 122 and/or the malicious C&C servers 118 which may be advertised to the controller 104 through OMP.

The network protection services 314 may further include a dynamic list updating component 322 to, when executed by the processor 302, assist the controller 104 in updating the dynamic lists 212 including providing the controller 104 with any updated or new IP addresses of networked devices as described herein.

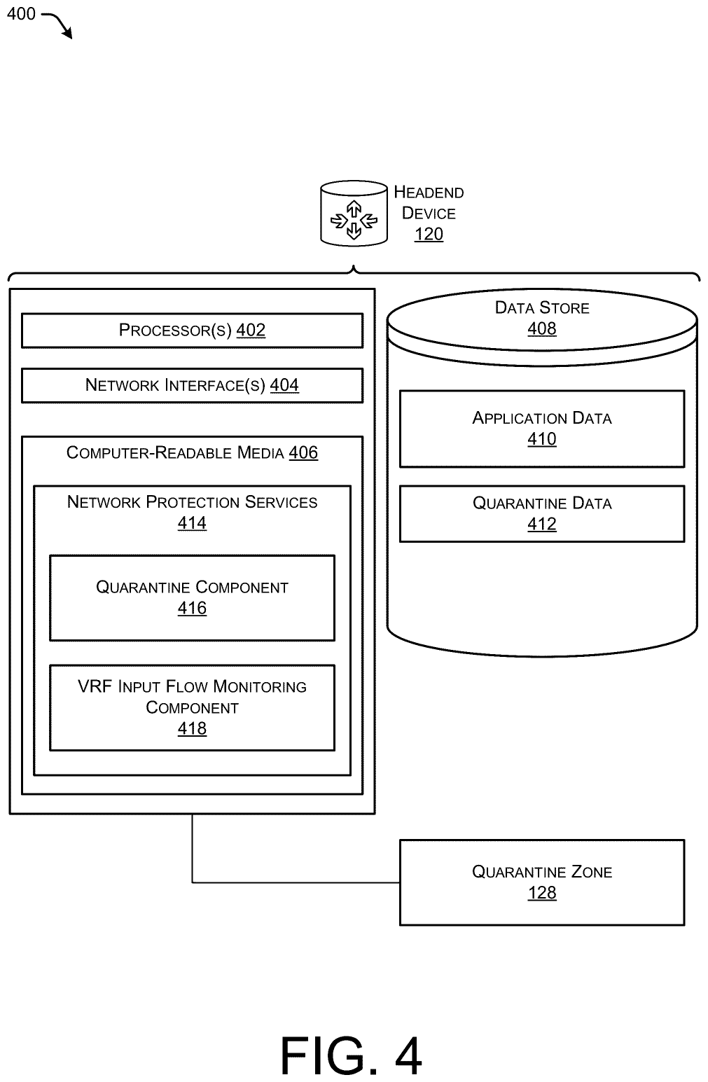

FIG. 4 is a component diagram 400 of example components of a headend device 120 including network protection services, according to an example of the principles described herein. As illustrated, the headend device 120 may include one or more hardware processor(s) 402 configured to execute one or more stored instructions. The processor(s) 402 may comprise one or more cores. Further, the headend device 120 may include one or more network interfaces 404 configured to provide communications between the headend device 120 and other devices, such as devices associated with the system architecture of FIG. 1 including the management system 102, the controller 104, the ISE 106, the fabric network 108, the underlay network 110, the edge devices 112, the data center 114, the internet 116 and computing devices therein, the C&C server 118, the user computing devices 122, the SQL DB 124, the quarantine zones 128, and/or other systems or devices associated with the headend device 120 and/or remote from the headend device 120. The network interfaces 404 may include devices configured to couple to personal area networks (PANs), wired and wireless local area networks (LANs), wired and wireless wide area networks (WANs), and so forth. For example, the network interfaces 404 may include devices compatible with the management system 102, the controller 104, the ISE 106, the fabric network 108, the underlay network 110, the edge devices 112, the data center 114, the internet 116 and computing devices therein, the C&C server 118, the user computing devices 122, the SQL DB 124, the quarantine zones 128 and/or other systems or devices associated with the headend device 120.

The headend device 120 may also include computer-readable media 406 that stores various executable components (e.g., software-based components, firmware-based components, etc.). In one example, the computer-readable media 406 may include, for example, working memory, random access memory (RAM), read only memory (ROM), and other forms of persistent, non-persistent, volatile, non-volatile, and other types of data storage. In addition to various components discussed herein, the computer-readable media 406 may further store components to implement functionality described herein. While not illustrated, the computer-readable media 406 may store one or more operating systems utilized to control the operation of the one or more devices that comprise the headend device 120. According to one example, the operating system comprises the LINUX operating system. According to another example, the operating system(s) comprise the WINDOWS SERVER operating system from MICROSOFT Corporation of Redmond, Washington. According to further examples, the operating system(s) may comprise the UNIX operating system or one of its variants. It may be appreciated that other operating systems may also be utilized.

Additionally, the headend device 120 may include a data store 408 which may comprise one, or multiple, repositories or other storage locations for persistently storing and managing collections of data such as databases, simple files, binary, and/or any other data. The data store 408 may include one or more storage locations that may be managed by one or more database management systems. The data store 408 may store, for example, application data 410 defining computer-executable code utilized by the processor 402 to execute the computer-readable media 406 including the network protection services 414. Further, the application data 410 may include quarantine data 412 defining which of a number of data packets or traffic received from a compromised user computing device 122 and/or the malicious C&C server 118 are to be quarantined in the quarantine zone 128.

The computer-readable media 406 may store portions, or components, of the network protection services 414. For instance, the network protection services 414 of the computer-readable media 406 may include a quarantine component 416 to, when executed by the processor(s) 402, execute an action including redirecting traffic from the compromised user computing device 122 and/or the malicious C&C server 118 to a quarantine zone (e.g., quarantining the traffic) as directed by the controller 104.

The network protection services 414 of the computer-readable media 406 may include a VRF input flow monitoring component 418 to, when executed by the processor 202, analyze incoming packets from the compromised user computing device 122 and/or the malicious C&C server 118 and received at the headend device 120 and collect the VRF ID from the incoming packets as a key field. With the key field, the VRF input flow monitoring component 234 may be used to then determine whether the incoming packets are to be quarantined based on instructions obtained from the controller 104 and the ISE 106.

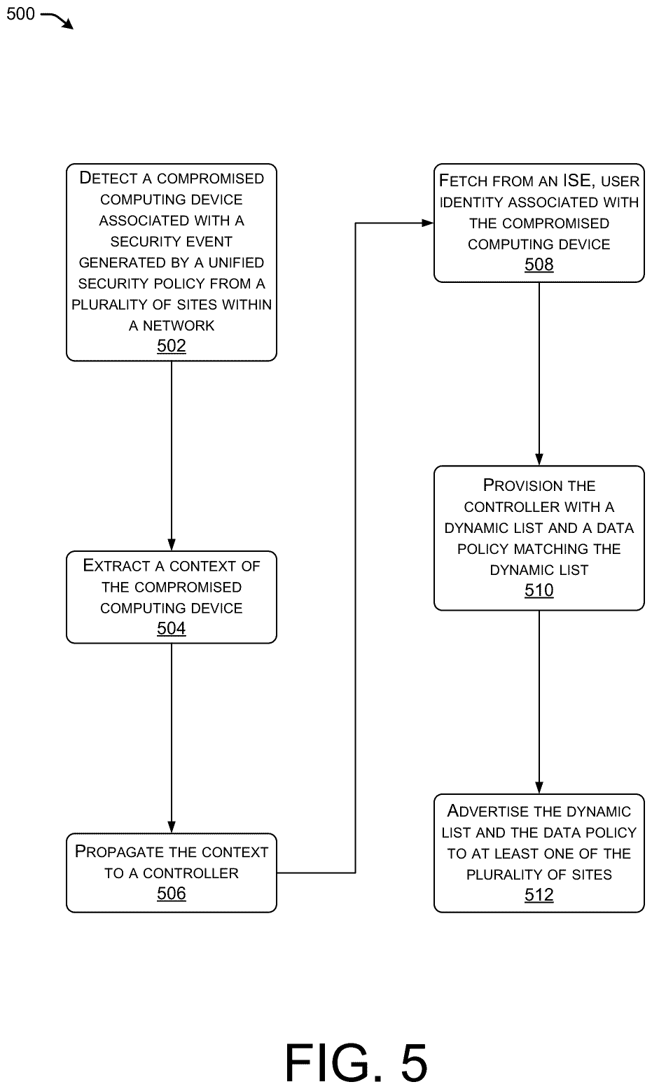

FIG. 5 illustrates a flow diagram of an example method 500 of protecting a network 100 from compromised computing devices, according to an example of the principles described herein. The method 500 of FIG. 5 may be performed by the management system 102, the controller 104, the ISE 106, the fabric network 108, the underlay network 110, the edge devices 112, the data center 114, the internet 116 and computing devices therein, the C&C server 118, the headend devices 120, the user computing devices 122, the SQL DB 124, the quarantine zones 128, other systems or devices associated with the network 100, and combinations thereof.

The method 500 of FIG. 5 may include, at 502, detecting a compromised computing device (e.g., the compromised user computing device 122 and/or the malicious C&C server 118) associated with a security event generated by a unified security policy from a plurality of sites within a network 100. At 504, a context of the compromised computing device may be extracted. The context may be propagated to the controller 104 at 506.

At 508, a user identity associated with the compromised computing device may be fetched from the ISE 106. The controller 104 may be provisioned with a dynamic list and a data policy matching the dynamic list at 510. At 512, the dynamic list and the data policy may be advertised to at least one of the plurality of remote sites 126 in order to ensure that the compromised computing device does not further compromise other networked computing devices.

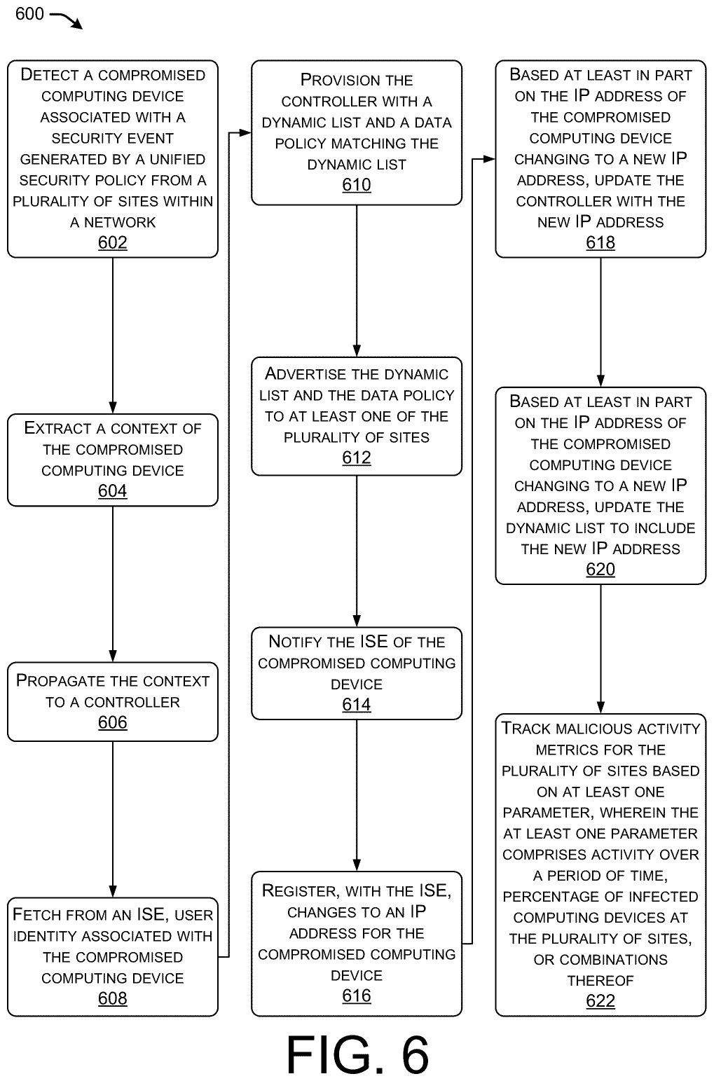

FIG. 6 illustrates a flow diagram of an example method 600 of protecting the network 100 from compromised computing devices, according to an example of the principles described herein. Like the method 500 of FIG. 5, the method 600 of FIG. 6 may be performed by the management system 102, the controller 104, the ISE 106, the fabric network 108, the underlay network 110, the edge devices 112, the data center 114, the internet 116 and computing devices therein, the C&C server 118, the headend devices 120, the user computing devices 122, the SQL DB 124, the quarantine zones 128, other systems or devices associated with the network 100, and combinations thereof.

The method 600 of FIG. 6 may include, at 602, detecting a compromised computing device (e.g., the compromised user computing device 122 and/or the malicious C&C server 118) associated with a security event generated by a unified security policy from a plurality of sites within a network 100. At 604, a context of the compromised computing device may be extracted. The context may be propagated to the controller 104 at 606. As described herein, the context may be advertised to the controller via overlay management protocol (OMP).

At 608, a user identity associated with the compromised computing device may be fetched from the ISE 106. The user identity may include a username associated with the compromised computing device, a geolocation of the compromised computing device, a quarantine virtual private network (VPN) associated with the compromised computing device, and combinations thereof. The controller 104 may be provisioned with a dynamic list 212 and a data policy 222 matching the dynamic list at 610. As described herein, the dynamic list 212 may include an IP address, a port, an application name, a security group tag (SGT), a username, and combinations thereof that are associated with the compromised computing device. Further, as described herein, the data policy 222 matching the dynamic list 212 may include pre-crafted rules 224 matching the dynamic list 212 and at least one action 226 to take based on the pre-crafted rules 224. At 612, the dynamic list 212 and the data policy 222 may be advertised to at least one of the plurality of remote sites 126 in order to ensure that the compromised computing device does not further compromise other networked computing devices. Advertising the dynamic list 212 and the data policy 222 to at least one of the plurality of sites may be based on a geolocation of the compromised computing device, based on a site list, based on user-defined criteria, and combinations thereof

At 614, the ISE 106 may be notified of the compromised computing device, and, at 616, changes to the IP address for the compromised computing device may be registered with the ISE 106 in order to ensure that any compromised computing device that obtains a new IP address is continually monitored and is not allowed, in its compromised state, to reconnect to the network 100 including the fabric network 108 and compromise the security of other networked computing devices.

Based at least in part on the IP address of the compromised computing device changing to a new IP address, at 618, the ISE 106 may update the controller 104 with the new IP address. At 620, the controller 104 and/or the ISE 106 may update the dynamic list to include the new IP address. A number of malicious activity metrics for the plurality of remote sites 126 may be tracked at 622 based on at least one parameter. The at least one parameter may include, for example, activity over a period of time, percentage of infected computing devices at the plurality of sites, and combinations thereof.

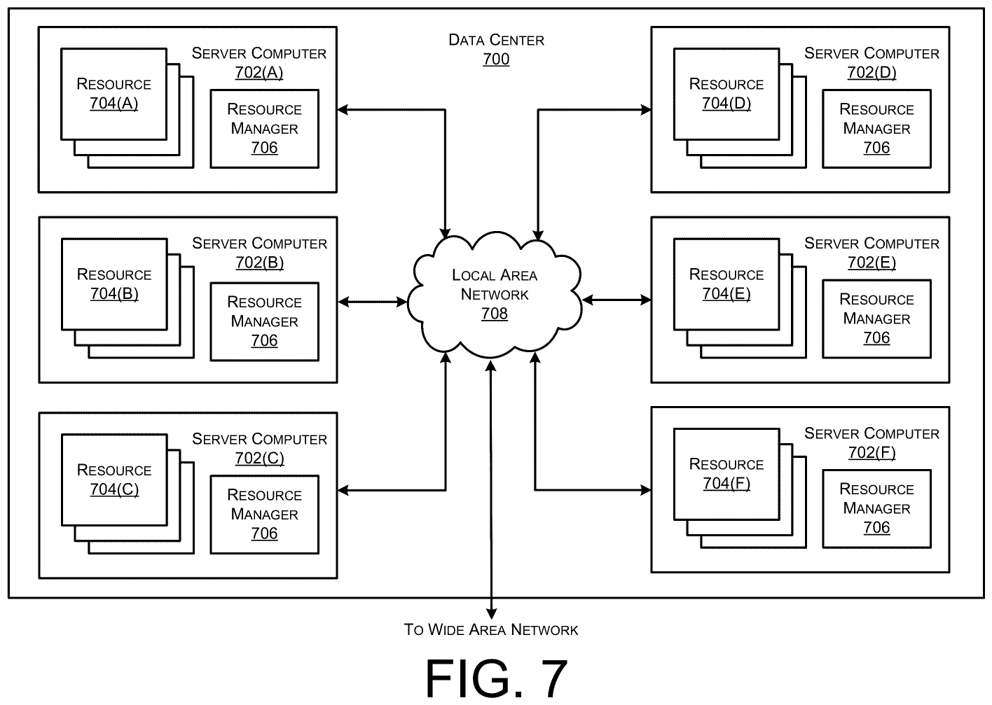

FIG. 7 illustrates a computing system diagram illustrating a configuration for a data center 700 that may be utilized to implement aspects of the technologies disclosed herein. The example data center 700 shown in FIG. 7 includes several server computers 702A-702F (which might be referred to herein singularly as “a server computer 702” or in the plural as “the server computers 702) for providing computing resources. In some examples, the resources and/or server computers 702 may include, or correspond to, any type of networked device described herein. Although described as servers, the server computers 702 may comprise any type of networked device, such as servers, switches, routers, hubs, bridges, gateways, modems, repeaters, access points, etc.

The server computers 702 may be standard tower, rack-mount, or blade server computers configured appropriately for providing computing resources. In some examples, the server computers 702 may provide computing resources 704 including data processing resources such as VM instances or hardware computing systems, database clusters, computing clusters, storage clusters, data storage resources, database resources, networking resources, virtual private networks (VPNs), and others. Some of the server computers 702 may also be configured to execute a resource manager 706 capable of instantiating and/or managing the computing resources. In the case of VM instances, for example, the resource manager 706 may be a hypervisor or another type of program configured to enable the execution of multiple VM instances on a single server computer 702. Server computers 702 in the data center 700 may also be configured to provide network services and other types of services.

In the example data center 700 shown in FIG. 7, an appropriate LAN 708 is also utilized to interconnect the server computers 702A-702F. It may be appreciated that the configuration and network topology described herein has been greatly simplified and that many more computing systems, software components, networks, and networking devices may be utilized to interconnect the various computing systems disclosed herein and to provide the functionality described above. Appropriate load balancing devices or other types of network infrastructure components may also be utilized for balancing a load between data centers 700, between each of the server computers 702A-702F in each data center 700, and, potentially, between computing resources in each of the server computers 702. It may be appreciated that the configuration of the data center 700 described with reference to FIG. 7 is merely illustrative and that other implementations may be utilized.

In some examples, the server computers 702 and or the computing resources 704 may each execute/host one or more tenant containers and/or virtual machines to perform techniques described herein.

In some instances, the data center 700 may provide computing resources, like tenant containers, VM instances, VPN instances, and storage, on a permanent or an as-needed basis. Among other types of functionality, the computing resources provided by a cloud computing network may be utilized to implement the various services and techniques described herein. The computing resources 704 provided by the cloud computing network may include various types of computing resources, such as data processing resources like tenant containers and VM instances, data storage resources, networking resources, data communication resources, network services, VPN instances, and the like.

Each type of computing resource 704 provided by the cloud computing network may be general-purpose or may be available in a number of specific configurations. For example, data processing resources may be available as physical computers or VM instances in a number of different configurations. The VM instances may be configured to execute applications, including web servers, application servers, media servers, database servers, some or all of the network services described above, and/or other types of programs. Data storage resources may include file storage devices, block storage devices, and the like. The cloud computing network may also be configured to provide other types of computing resources 704 not mentioned specifically herein.

The computing resources 704 provided by a cloud computing network may be enabled in one example by one or more data centers 700 (which might be referred to herein singularly as “a data center 700” or in the plural as “the data centers 700). The data centers 700 are facilities utilized to house and operate computer systems and associated components. The data centers 700 typically include redundant and backup power, communications, cooling, and security systems. The data centers 700 may also be located in geographically disparate locations. One illustrative example for a data center 700 that may be utilized to implement the technologies disclosed herein is described herein with regard to, for example, FIGS. 1 through 6.

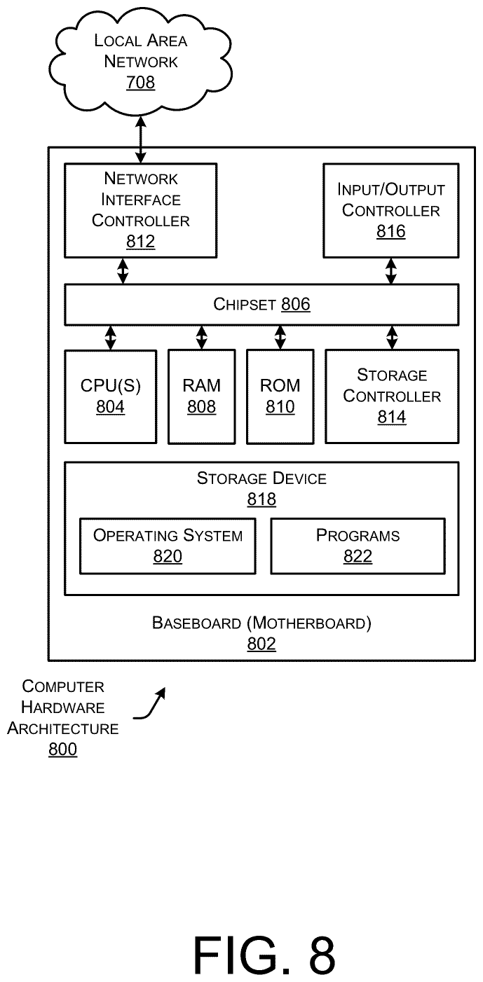

FIG. 8 illustrates a computer architecture diagram showing an example computer hardware architecture 800 for implementing a computing device that may be utilized to implement aspects of the various technologies presented herein. The computer hardware architecture 800 shown in FIG. 8 illustrates the management system 102, the controller 104, the ISE 106, the fabric network 108, the underlay network 110, the edge devices 112, the data center 114, the internet 116 and computing devices therein, the C&C server 118, the headend devices 120, the user computing devices 122, the SQL DB 124, the quarantine zones 128, and/or other systems or devices associated with the network 100 and/or remote from the network 100, a workstation, a desktop computer, a laptop, a tablet, a network appliance, an e-reader, a smartphone, or other computing device, and may be utilized to execute any of the software components described herein. The computer 800 may, in some examples, correspond to a network device (e.g., management system 102, the controller 104, the ISE 106, the fabric network 108, the underlay network 110, the edge devices 112, the data center 114, the internet 116 and computing devices therein, the C&C server 118, the headend devices 120, the user computing devices 122, the SQL DB 124, and/or the quarantine zones 128 described herein, and may comprise networked devices such as servers, switches, routers, hubs, bridges, gateways, modems, repeaters, access points, etc.

The computer 800 includes a baseboard 802, or “motherboard,” which is a printed circuit board to which a multitude of components or devices may be connected by way of a system bus or other electrical communication paths. In one illustrative configuration, one or more central processing units (CPUs) 804 operate in conjunction with a chipset 806. The CPUs 804 may be standard programmable processors that perform arithmetic and logical operations necessary for the operation of the computer 800.

The CPUs 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 may provide an interface to a RAM 808, used as the main memory in the computer 800. The chipset 806 may further provide an interface to a computer-readable storage medium such as a read-only memory (ROM) 810 or non-volatile RAM (NVRAM) for storing basic routines that help to startup the computer 800 and to transfer information between the various components and devices. The ROM 810 or NVRAM may also store other software components necessary for the operation of the computer 800 in accordance with the configurations described herein.

The computer 800 may operate in a networked environment using logical connections to remote computing devices and computer systems through a network, such as the management system 102, the controller 104, the ISE 106, the fabric network 108, the underlay network 110, the edge devices 112, the data center 114, the internet 116 and computing devices therein, the C&C server 118, the headend devices 120, the user computing devices 122, the SQL DB 124, and the quarantine zones 128, among other devices. The chipset 806 may include functionality for providing network connectivity through a Network Interface Controller (NIC) 812, such as a gigabit Ethernet adapter. The NIC 812 is capable of connecting the computer 800 to other computing devices within the network 100 and external to the network 100. It may be appreciated that multiple NICs 812 may be present in the computer 800, connecting the computer to other types of networks and remote computer systems. In some examples, the NIC 812 may be configured to perform at least some of the techniques described herein, such as packet redirects and/or other techniques described herein.

The computer 800 may be connected to a storage device 818 that provides non-volatile storage for the computer. The storage device 818 may store an operating system 820, programs 822 (e.g., any computer-readable and/or computer-executable code described herein), and data, which have been described in greater detail herein. The storage device 818 may be connected to the computer 800 through a storage controller 814 connected to the chipset 806. The storage device 818 may consist of one or more physical storage units. The storage controller 814 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computer 800 may store data on the storage device 818 by transforming the physical state of the physical storage units to reflect the information being stored. The specific transformation of physical state may depend on various factors, in different examples of this description. Examples of such factors may include, but are not limited to, the technology used to implement the physical storage units, whether the storage device 818 is characterized as primary or secondary storage, and the like.

For example, the computer 800 may store information to the storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 800 may further read information from the storage device 818 by detecting the physical states or characteristics of one or more particular locations within the physical storage units.

In addition to the storage device 818 described above, the computer 800 may have access to other computer-readable storage media to store and retrieve information, such as program modules, data structures, or other data. It may be appreciated by those skilled in the art that computer-readable storage media is any available media that provides for the non-transitory storage of data and that may be accessed by the computer 800. In some examples, the operations performed by the management system 102, the controller 104, the ISE 106, the fabric network 108, the underlay network 110, the edge devices 112, the data center 114, the internet 116 and computing devices therein, the C&C server 118, the headend devices 120, the user computing devices 122, the SQL DB 124, the quarantine zones 128, and or any components included therein, may be supported by one or more devices similar to computer 800. Stated otherwise, some or all of the operations performed by the management system 102, the controller 104, the ISE 106, the fabric network 108, the underlay network 110, the edge devices 112, the data center 114, the internet 116 and computing devices therein, the C&C server 118, the headend devices 120, the user computing devices 122, the SQL DB 124, the quarantine zones 128, and or any components included therein, may be performed by one or more computer devices operating in a cloud-based arrangement.

By way of example, and not limitation, computer-readable storage media may include volatile and non-volatile, removable and non-removable media implemented in any method or technology. Computer-readable storage media includes, but is not limited to, RAM, ROM, erasable programmable ROM (EPROM), electrically-erasable programmable ROM (EEPROM), flash memory or other solid-state memory technology, compact disc ROM (CD-ROM), digital versatile disk (DVD), high definition DVD (HD-DVD), BLU-RAY, or other optical storage, magnetic cassettes, magnetic tape, magnetic disk storage or other magnetic storage devices, or any other medium that may be used to store the desired information in a non-transitory fashion.

As mentioned briefly above, the storage device 818 may store an operating system 820 utilized to control the operation of the computer 800. According to one example, the operating system 820 comprises the LINUX operating system. According to another example, the operating system comprises the WINDOWS® SERVER operating system from MICROSOFT Corporation of Redmond, Washington. According to further examples, the operating system may comprise the UNIX operating system or one of its variants. It may be appreciated that other operating systems may also be utilized. The storage device 818 may store other system or application programs and data utilized by the computer 800.

In one example, the storage device 818 or other computer-readable storage media is encoded with computer-executable instructions which, when loaded into the computer 800, transform the computer from a general-purpose computing system into a special-purpose computer capable of implementing the examples described herein. These computer-executable instructions transform the computer 800 by specifying how the CPUs 804 transition between states, as described above. According to one example, the computer 800 has access to computer-readable storage media storing computer-executable instructions which, when executed by the computer 800, perform the various processes described above with regard to FIGS. 1 through 7. The computer 800 may also include computer-readable storage media having instructions stored thereupon for performing any of the other computer-implemented operations described herein.

The computer 800 may also include one or more input/output controllers 816 for receiving and processing input from a number of input devices, such as a keyboard, a mouse, a touchpad, a touch screen, an electronic stylus, or other type of input device. Similarly, an input/output controller 816 may provide output to a display, such as a computer monitor, a flat-panel display, a digital projector, a printer, or other type of output device. It will be appreciated that the computer 800 might not include all of the components shown in FIG. 8, may include other components that are not explicitly shown in FIG. 8, or might utilize an architecture completely different than that shown in FIG. 8.

As described herein, the computer 800 may comprise one or more of the management system 102, the controller 104, the ISE 106, the fabric network 108, the underlay network 110, the edge devices 112, the data center 114, the internet 116 and computing devices therein, the C&C server 118, the headend devices 120, the user computing devices 122, the SQL DB 124, the quarantine zones 128, and/or other systems or devices associated with the network 100 and/or remote from the network 100. The computer 800 may include one or more hardware processor(s) such as the CPUs 804 configured to execute one or more stored instructions. The CPUs 804 may comprise one or more cores. Further, the computer 800 may include one or more network interfaces configured to provide communications between the computer 800 and other devices, such as the communications described herein as being performed by the management system 102, the controller 104, the ISE 106, the fabric network 108, the underlay network 110, the edge devices 112, the data center 114, the internet 116 and computing devices therein, the C&C server 118, the headend devices 120, the user computing devices 122, the SQL DB 124, the quarantine zones 128, and other devices described herein. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 822 may comprise any type of programs or processes to perform the techniques described in this disclosure for the management system 102, the controller 104, the ISE 106, the fabric network 108, the underlay network 110, the edge devices 112, the data center 114, the internet 116 and computing devices therein, the C&C server 118, the headend devices 120, the user computing devices 122, the SQL DB 124, the quarantine zones 128 as described herein. The programs 822 may enable the devices described herein to perform various operations.

### CONCLUSION

The examples described herein provide systems and methods for connected security in the fabric network 108 (e.g., an SDWAN fabric network). Further, automatic security learnings from each remote site 126 may be obtained that may be proactively propagated to other remote sites 126. A compromised user computing device 122 and context associated with the compromised user computing device 122 may be identified from a security threat event and may be dynamically relayed to the controller 104. Further, the controller 104 may perform selective distribution of threat to the remote sites 126 based on user-identity, geo-location of the compromised user computing device 122, location of the compromised remote site 126, other parameters, and combinations thereof. User intervention throughout the automated processes described herein is unnecessary when a new user computing device 122 is added to the network 100 including the fabric network 108.

Further, with the present systems and methods, manual configuration change in policies is not required in order to accommodate matched for new user computing devices 122. The controller 104 may handle changes to the IP addresses of the compromised user computing device 122 and/or the malicious C&C server 118 using communications with the ISE 106 in order to seamlessly propagate these changes to relevant or appropriate remote sites 126. Further, the controller 104 may track malicious activity on the remote sites 126 over a period of time and/or for a percentage of user computing devices 122 infected at the remote site 126. Still further, the controller may protect the remote sites 126 from compromising security threats by auto-installing policies to withdraw routes and/or TLOC.

The present systems and methods may provide a collective visualization of the security posture of the fabric network 108 and the network 100 as a whole. Further, improved use of available resources across the network 100 including the fabric network 108 may be realized. Without the learning and distribution features of the present systems and methods, the security services must spend additional cycles to detect security threats. Thus, the present systems and methods saves overall turnaround time for security threat detection and remediation. Further, for remote sites 126 that do not have a firewall or other security tools where traffic may be steered for security inspection, the present systems and methods provide for detection of user computing devices 122 at a remote site 126. This will conserve bandwidth within the fabric network 108.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A method of protecting networks, comprising:
detecting a compromised computing device associated with a security event generated by a unified security policy from a plurality of sites within a network;
extracting a context of the compromised computing device;
propagating the context to a controller;
fetching from an identity services engine (ISE), user identity associated with the compromised computing device;
provisioning the controller with a dynamic list and a data policy matching the dynamic list;
propagating the context into the dynamic list referenced under a data policy; and
advertising the dynamic list and the data policy to at least one of the plurality of sites.

2. The method of claim 1, further comprising:
notifying the ISE of the compromised computing device; and
registering, with the ISE, changes to an IP address for the compromised computing device.

3. The method of claim 2, further comprising, based at least in part on the IP address of the compromised computing device changing to a new IP address, updating the dynamic list to include the new IP address.

4. The method of claim 1, wherein the dynamic list comprises an IP address, a port, an application name, a security group tag (SGT), a username, or combinations thereof that are associated with the compromised computing device.

5. The method of claim 1, wherein the data policy comprises:
pre-crafted rules matching the dynamic list; and
at least one action to take based on the pre-crafted rules.

6. The method of claim 1, further comprising tracking malicious activity metrics for the plurality of sites based on at least one parameter, wherein the at least one parameter comprises activity over a period of time, percentage of infected computing devices at the plurality of sites, or combinations thereof.

7. The method of claim 1, wherein the user identity comprises a username associated with the compromised computing device, a geolocation of the compromised computing device, a quarantine virtual private network (VPN) associated with the compromised computing device, or combinations thereof.

8. The method of claim 1, wherein the context is advertised to the controller via overlay management protocol (OMP).

9. The method of claim 1, wherein advertising the dynamic list and the data policy to at least one of the plurality of sites is based on a geolocation of the compromised computing device, based on a site list, based on user-defined criteria, or combinations thereof.

10. A non-transitory computer-readable medium storing instructions that, when executed, causes a processor to perform operations, comprising:
detecting a compromised computing device associated with a security event generated by a unified security policy from a plurality of sites within a network;
extracting a context of the compromised computing device;
propagating the context to a controller;
fetching from an identity services engine (ISE), user identity associated with the compromised computing device;
provisioning the controller with a dynamic list and a data policy matching the dynamic list; and
advertising the dynamic list and the data policy to at least one of the plurality of sites.

11. The non-transitory computer-readable medium of claim 10, the operations further comprising:
notifying the ISE of the compromised computing device;
registering, with the ISE, changes to an IP address for the compromised computing device;
based at least in part on the IP address of the compromised computing device changing to a new IP address, updating the dynamic list to include the new IP address.

12. The non-transitory computer-readable medium of claim 10, wherein:
the dynamic list comprises an IP address, a port, an application name, a security group tag (SGT), a username, or combinations thereof that are associated with the compromised computing device; and
the data policy comprises:
pre-crafted rules matching the dynamic list; and
at least one action to take based on the pre-crafted rules.

13. The non-transitory computer-readable medium of claim 10, the operations further comprising tracking malicious activity metrics for the plurality of sites based on at least one parameter, wherein the at least one parameter comprises activity over a period of time, percentage of infected computing devices at the plurality of sites, or combinations thereof.

14. The non-transitory computer-readable medium of claim 10, wherein advertising the dynamic list and the data policy to at least one of the plurality of sites is based on a geolocation of the compromised computing device, based on a site list, based on user-defined criteria, or combinations thereof.

15. A controller comprising:
a processor; and
a non-transitory computer-readable media storing instructions that, when executed by the processor, causes the processor to perform operations comprising:
receiving a context of a compromised computing device associated with a security event generated by a unified security policy from a plurality of sites within a network;
fetching from an identity services engine (ISE), user identity associated with the compromised computing device;
provisioning a dynamic list and a data policy matching the dynamic list; and
advertising the dynamic list and the data policy to at least one of the plurality of sites.

16. The controller of claim 15, the operations further comprising:
notifying the ISE of the compromised computing device; and
registering, with the ISE, changes to an IP address for the compromised computing device.

17. The controller of claim 16, the operations further comprising:
based at least in part on the IP address of the compromised computing device changing to a new IP address:
updating the controller with the new IP address; and
updating the dynamic list to include the new IP address.

18. The controller of claim 15, wherein the data policy comprises:
pre-crafted rules matching the dynamic list; and
at least one action to take based on the pre-crafted rules.

19. The controller of claim 15, the operations further comprising tracking malicious activity metrics for the plurality of sites based on at least one parameter, wherein the at least one parameter comprises activity over a period of time, percentage of infected computing devices at the plurality of sites, or combinations thereof.

20. The controller of claim 15, wherein advertising the dynamic list and the data policy to at least one of the plurality of sites is based on a geolocation of the compromised computing device, based on a site list, based on user-defined criteria, or combinations thereof.
